(19) United States
(12) Patent Application Publication
(10) Pub. No.: US 2026/0260553 A1
(43) Pub. Date: Sep. 3, 2026

(54) ARTIFICIAL INTELLIGENCE IOT WATER SAFETY MONITORING SYSTEM

(71) Applicant: Fortune AI Technologies CO., LTD., Taoyuan City (TW)

(72) Inventor: CHIN-JU CHEN, Taipei City (TW)

(21) Appl. No.: 19/554,310

(22) Filed: Mar. 2, 2026

(30) Foreign Application Priority Data
Mar. 3, 2025 (TW) 114107780

(51) Int. Cl. G08B 21/08; G06V 10/80; G06V 10/82; G06V 20/52; G06V 40/10; G06V 40/20; G08B 3/10

(52) U.S. Cl. CPC G08B 21/08; G06V 10/803; G06V 10/82; G06V 20/52; G06V 40/10; G06V 40/20; G08B 3/10

(57) ABSTRACT

The present disclosure relates to an underwater monitoring system that continuously captures aquatic imagery via an underwater image-capturing device and transmits the images to an edge-computing node for analysis. The node-integrated AI target-detection module comprises three submodules: a visual attention heatmap tracking submodule, a skeleton dynamics sequence analysis submodule, and a multi-modal fusion decision submodule. These submodules respectively extract abnormal heatmap regions, limb coordination, trunk stability, and vertical-sinking dynamic metrics to generate a risk score for each target. Additionally, the system includes a generative AI module that interprets data from the visual attention and skeleton-dynamics submodules to provide supplemental risk scores and textual descriptions. When any target's combined risk score exceeds a predefined threshold, a processing and alert-issuance module immediately issues a warning. This system effectively monitors underwater environments for anomalies and provides real-time alerts to mitigate potential hazards.

### CROSS-REFERENCE TO RELATED APPLICATION

This application claims the priority of Taiwan Patent Application No. 114107780, filed on Mar. 3, 2025, the content of which is incorporated herein by reference in its entirety.

### TECHNICAL FIELD

The present patent relates to the field of applying artificial intelligence IoT module technology to a water safety monitoring system. Specifically, it refers to an edge-computing device for analysis, which has a built-in AI target-detection module comprising three submodules: a visual attention heatmap tracking submodule, a skeleton dynamic sequence analysis submodule, and a multi-modal fusion decision submodule. These submodules are respectively responsible for extracting abnormal heatmap regions, limb coordination, trunk stability, vertical sinking, and other dynamic metrics, and based on this, generating a risk score for each target. Additionally, the edge-computing device includes a generative AI module that interprets data from the visual attention heatmap tracking and skeleton dynamic sequence analysis submodules to provide drowning or falling risk scores and/or the target's textual description. When the comprehensive risk score of any target exceeds a preset threshold, the processing and alert-issuance module will immediately issue a warning, providing a final review to reduce false alarms.

### BACKGROUND

Traditional pool safety monitoring systems primarily rely on human monitoring and simple camera surveillance technology. These systems typically only provide basic video recording functions and lack intelligent analysis capabilities, making them unable to promptly identify and warn of potential drowning or falling risks. Early systems mainly depended on human observation, which is susceptible to human factors and cannot timely identify potential drowning or falling risks. With technological advancements, computer vision-based object detection technologies have gradually been introduced.

However, these technologies still have shortcomings in terms of accuracy and real-time performance. Furthermore, existing camera-based surveillance systems generally lack intelligent analysis capabilities, making them unable to accurately identify and classify target behaviors, thus failing to provide effective risk assessment and warnings. Issues such as response delays, false alarms, and missed detections exist. Single object detection or behavior recognition algorithms struggle to cope with complex environmental changes and also lack dynamic dataset updates to continuously improve model accuracy. Moreover, unstable hardware equipment and network connections often affect the performance of monitoring systems.

Furthermore, traditional water target tracking techniques typically rely on capturing high-resolution images from elevated positions and directly extracting or storing the face, head, and full-body contours of targets, thereby raising serious privacy and data security risks: First, facial and body features constitute highly personal identifiable information; if stored long-term or leaked without authorization, they are highly susceptible to misuse or re-identification, violating global privacy regulations such as GDPR and CCPA. Second, if end-to-end encryption is not implemented between edge nodes and cloud servers, image data is highly vulnerable to interception or theft by hackers during transmission or storage. Third, capturing and analyzing biometric data without obtaining explicit consent may not only breach laws but also trigger trust crises and ethical controversies among users and the general public. Additionally, processing high-definition images consumes substantial bandwidth, storage, and computational resources, significantly increasing system deployment and maintenance costs. Finally, facial and identity recognition models are prone to bias or misjudgment under different lighting, occlusion, or demographic backgrounds, not only reducing detection accuracy but also further undermining user trust in the system. These shortcomings highlight the urgent need for new anonymized or non-intrusive underwater monitoring technologies that prioritize the protection of personal privacy and information security.

To address this, a multi-layered safety monitoring system is required, integrating real-time image analysis, Al deep learning, and generative AI technologies, along with comprehensive hardware configuration and on-site deployment planning.

### SUMMARY

To solve the aforementioned problems, the main object of this disclosure is to address the current reliance of water safety monitoring systems on high-resolution image detection of splashes or human contours, which is prone to misjudgment/missed detection due to water surface glare, obstructions, or complex scene interference. Simultaneously, directly capturing and storing facial and full-body contours introduces risks of personal data leakage and regulatory compliance issues. Moreover, a single detection mode cannot adequately distinguish between swimmers' normal movements and abnormal struggling, and the long-term storage and processing of high-definition images substantially increase costs and bandwidth burdens.

The present disclosure addresses the above technical challenges by proposing a non-intrusive drowning detection solution that combines visual attention heatmap analysis with multi-modal skeleton dynamic sequence judgment. This disclosure is an artificial intelligence Internet of Things (IoT) water safety monitoring system, deployed in a water to monitor a plurality of targets, including: an image-capturing device, which is connected to an edge-computing device, and the image-capturing device captures real-time images of the water and transmits them to the edge-computing device; an artificial intelligence target-detection module, which is installed in the edge-computing device and includes a visual attention heatmap tracking analysis submodule, which uses image saliency analysis technology to generate a real-time dynamic attention heatmap from the captured water images, an AI multi-modal human skeleton dynamic sequence analysis submodule, which extracts in real time the trunk skeletal node sequence characteristics and limb skeletal node sequence characteristics of the plurality of targets from the captured water images, and a multi-modal fusion decision neural network submodule, which receives the visual attention heatmap and the skeleton dynamic sequence characteristics, and calculates dynamic metrics of limb coordination, trunk motion stability, and vertical sinking of the plurality of targets, highlights abnormal visual characteristics such as abnormal splashing and rapid sinking, uses abnormal regions in the visual attention heatmap as fusion decision triggers, and generates a target risk score when both the dynamic metric analysis results and the abnormal visual characteristics simultaneously reach preset anomaly thresholds; a generative artificial intelligence module, which is installed in the edge-computing device and transmits the visual attention heatmaps and the skeleton dynamic sequence characteristics to the generative artificial intelligence module for interpreting the target behaviors so that the generative artificial intelligence module generates the target's drowning or falling risk score and/or the target's textual description based on the visual attention heatmap and the skeleton dynamic sequence characteristics; and a processing and alert-issuance module, which is installed in the edge-computing device, which, when a combined score of the target risk score and the target's drowning or falling risk score exceeds a preset threshold, triggers the processing and alert-issuance module to issue alert notifications.

In an embodiment, the generative artificial intelligence module may further schedule generation of a simulated visual attention heatmap and a simulated skeleton dynamic sequence characteristic.

In an embodiment, the artificial intelligence IoT water safety monitoring system may further include an audio alarm device and a visual warning device, wherein the audio alarm device and the visual warning device are connected to the edge-computing device.

In an embodiment, the processing and alert-issuance module may send the notifications via a real-time communication tool, an SMS, an Email, and/or a Gateway.

In an embodiment, the generative artificial intelligence module uses generative adversarial networks or Vision Encoder and Language Model-based multi-modal technology for risk assessment and scenario description generation.

In an embodiment, the visual attention heatmap tracking analysis submodule inputs the real-time images of the water captured by the image-capturing device into a visual attention heatmap analysis model to generate a real-time visual attention heatmap, where dynamically salient regions are highlighted in an image area, optionally comprising abnormal visual characteristics selected from abnormal splashing, abnormal bubbles, rapid target sinking, or any combination thereof.

In an embodiment, the multi-modal human skeleton dynamic sequence analysis submodule employs a lightweight multi-modal skeleton recognition model, optionally HRNet or MobileNet combined with a Transformer neural network architecture, to identify skeleton nodes of individuals in a pool in real time and generate skeleton dynamic sequence characteristics.

In an embodiment, the target-detection module further includes a positioning module configured to calculate relative coordinate positions of the targets in a planar graph of the water based on the images of the water from the artificial intelligence target-detection module, and the processing and alert-issuance module then transmits the relative coordinate positions to the generative artificial intelligence module to generate descriptions of the positions of the targets.

To address the aforementioned issues, the present disclosure may be a water safety monitoring method based on artificial intelligence IoT for monitoring a plurality of targets in a water, including the following steps: Step 1, image capturing step: capturing continuous real-time images of the water by an image-capturing device and transmitting the images to an edge-computing device; Step 2, tracking analysis step: in the edge-computing device, applying image saliency analysis techniques (e.g., Grad-CAM) to the captured water images by a visual attention heatmap tracking analysis submodule to generate a real-time dynamic attention heatmap to highlight abnormal splashing, rapid sinking and other abnormal visual characteristics, and simultaneously, in the same edge-computing device, extracting in real time limb and trunk skeleton node sequence characteristics of the plurality of targets from the images of the water by a multi-modal human skeleton dynamic sequence analysis submodule, and calculating limb coordination, trunk motion stability, vertical sinking speed and acceleration and other dynamic metrics; Step 3, multi-modal fusion decision step: inputting the visual attention heatmap characteristics from Step 2 and the skeleton dynamic sequence characteristics into a multi-modal fusion decision neural network submodule, using abnormal regions in the visual attention heatmap as trigger points for fusion decision, and when analysis results of the dynamic metrics and abnormal visual characteristics simultaneously reach preset anomaly thresholds, generating a risk score of each target; Step 4, generative artificial intelligence interpretation step: in the edge-computing device, transmitting an attention heatmap and a skeleton characteristic output from Steps two and three to a generative artificial intelligence module, and the generative artificial intelligence module performing semantic interpretation for behaviors of the targets and generating drowning or falling risk scores and/or textual descriptions of the targets; and Step 5, alert processing and issuance step: in the edge-computing device, weighting and combining the risk scores generated in Step 4 with the risk score generated in step 5, and when a combined score exceeds a preset threshold, triggering a processing and alert-issuance module to issue real-time alert notifications.

Preferably, the Step 2 further includes a real-time dynamic pixelation masking step, where pixelation processing is performed on areas approximately 10 to 20 centimeters around skeleton nodes of the targets, and only the skeleton nodes and heatmap attention data are stored.

### BRIEF DESCRIPTION OF DRAWINGS

FIG. 1 is a schematic diagram of a preferred embodiment of the present disclosure;

FIG. 2 is a flowchart of steps of a preferred embodiment of the present disclosure.

### DESCRIPTION OF EMBODIMENTS

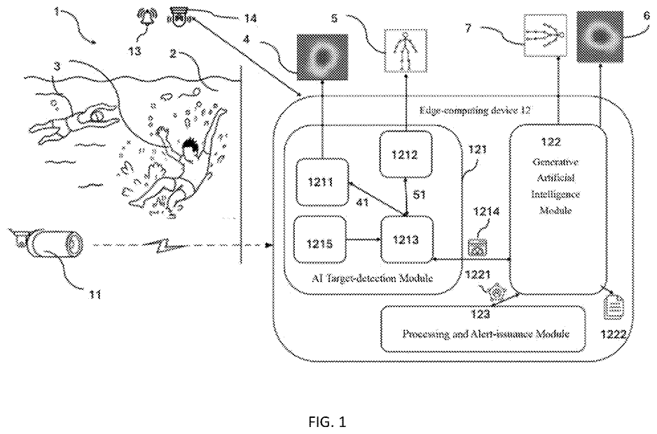

To more clearly describe an artificial intelligence IoT water safety monitoring system proposed by the present disclosure, the preferred embodiments of the disclosure are described in detail below with reference to the drawings. Please refer to FIG. 1, which is a schematic diagram of a preferred embodiment of the present disclosure. The FIG. discloses an artificial intelligence IoT water safety monitoring system 1, which is set up in a water 2 to monitor a plurality of targets 3. It includes: an image-capturing device 11, which captures images of the water 2 in real time and transmits them to an edge-computing device 12; an artificial intelligence target-detection module 121, which is set up in the edge-computing device 12. The artificial intelligence target-detection module 121 has a visual attention heatmap tracking analysis submodule 1211, which uses image saliency analysis technology to generate a real-time dynamic attention heatmap 4 from the captured images of the water 2, and an AI multi-modal human skeleton dynamic sequence analysis submodule 1212, which extracts and generates the trunk's skeletal node sequence characteristics 5 of the limbs and trunk of the plurality of targets 3 from the captured images of the water 2 in real time, and a multi-modal fusion decision neural network submodule 1213. The multi-modal fusion decision neural network submodule 1213 receives the visual attention heatmap 4 and the skeleton dynamic sequence characteristics 5, calculates the dynamic metrics of limb coordination, trunk motion stability, and vertical sinking of the plurality of targets 3, as well as highlights abnormal visual characteristics such as abnormal splashing and rapid sinking. Using abnormal regions in the visual attention heatmap as trigger points for fusion decision, it generates a skeleton dynamic metrics analysis result 51 and, when the abnormal visual characteristics 41 simultaneously reach a preset anomaly threshold, generates a target risk score 1214; a generative artificial intelligence module 122, which is set up in the edge-computing device 12. The edge-computing device 12 transmits the visual attention heatmap 4 and the skeleton dynamic sequence characteristics 5 to the generative artificial intelligence module 122 for interpreting the behavior of the targets 3. The generative artificial intelligence module 122 generates the target's drowning or falling risk score 1221 and/or the target's textual description 1222 based on the visual attention heatmap 4 and the skeleton dynamic sequence characteristics 5; and a processing and alert-issuance module 123, which is set up in the edge-computing device 12. When the comprehensive score of the target risk score 1214 and the target's drowning or falling risk score 1221 exceeds a preset threshold, the edge-computing device 12 triggers the processing and alert-issuance module 123 to issue an alert notification.

In this embodiment, the generative artificial intelligence module can further be scheduled to generate a simulated visual attention heatmap 6 and a simulated skeleton dynamic sequence characteristic 7, which can be used for model training.

In this embodiment, the artificial intelligence IoT water safety monitoring system 1 further includes an audio alarm device 13 and a visual warning device 14, with the audio alarm device 13 and the visual warning device 14 connected to the edge-computing device 12 via wired or wireless means.

In this embodiment, the processing and alert-issuance module 123 can send notifications via a real-time communication tool, an SMS, an Email, and/or a Gateway.

In this embodiment, the generative artificial intelligence module 122 uses generative adversarial networks or Vision Encoder and Language Model-based multimodal technology for risk assessment and scenario description generation.

In this embodiment, the visual attention heatmap tracking analysis submodule 1211 inputs the image of the water 2 captured in real-time by the image-capturing device 11 into a visual attention heatmap analysis model to generate a real-time visual attention heatmap 4. The visual attention heatmap 4 emphasizes dynamically salient regions within the image area, which can be selected from abnormal visual characteristics such as abnormal splashes, abnormal bubbles, rapid target sinking, or a combination thereof. The visual attention heatmap analysis model is an interpretability technique based on a deep convolutional neural network (CNN), combined with gradient backpropagation information to dynamically highlight the most discriminative regions in an image. First, a pre-trained CNN architecture for object detection or classification (such as ResNet, VGG, or MobileNet) is selected, with the final convolutional layer designated as the feature map output layer. For each input image, the model performs forward propagation to obtain classification scores, such as “abnormal” or “normal,” followed by backpropagation on these scores to compute the gradients for each channel in the final convolutional layer across spatial coordinates. Next, these gradients are globally averaged over the spatial dimensions to generate channel weights, reflecting the relative importance of each channel to the classification result. Finally, the feature maps of each channel are multiplied by their corresponding weights, summed, and passed through a ReLU function to remove negative contributions. The result is then interpolated and upscaled to the original image size, yielding a color heatmap. This heatmap typically uses a red-yellow-green-blue gradient to indicate attention intensity, clearly highlighting abnormal visual characteristics such as abnormal splashes, rapid sinking, or bubble clusters, without storing any facial or body contour information, relying entirely on heatmap intensity as the basis for anomaly detection. In edge computing environments, to balance real-time performance and computational resources, lightweight variants of Grad-CAM such as Grad-CAM++ or Score-CAM can be employed; faster implementations can be achieved by retaining only a subset of channels or using blind masking to quickly estimate channel contributions. To further enhance robustness, techniques like Integrated Gradients or SmoothGrad can be integrated, averaging heatmaps from a plurality of noise-perturbed images to reduce noise impact, and fine-tuning the ReLU threshold based on scene characteristics to avoid over-diffusion or suppression of weak signals. Overall, the visual attention heatmap analysis model not only precisely identifies the most judgmentally valuable dynamic regions in water footage without exposing personal data but also seamlessly integrates with skeleton sequence analysis and multimodal fusion decision networks, providing an efficient, interpretable, and privacy-regulation-compliant water safety monitoring solution.

In this embodiment, the AI multi-modal human skeleton dynamic sequence analysis submodule 1212 employs a lightweight multi-modal skeleton recognition model, which can be selected from HRNet or MobileNet combined with a Transformer neural network architecture, to identify the skeleton nodes of target 3 in the pool in real-time and generate skeleton dynamic sequence characteristics. The AI multi-modal human skeleton dynamic sequence analysis submodule 1212, based on a lightweight skeleton recognition model and a self-attention mechanism, is optimized for edge computing environments to achieve efficient real-time processing. First, it performs denoising and standardization on the frames from the image capture device 11, feeds them into the HRNet or MobileNet backbone network to extract multi-scale feature maps, and uses a keypoint detection head to locate the two-dimensional coordinates of nodes including only the limbs (both hands and feet) and the trunk (chest, abdomen); to comprehensively protect privacy, it intentionally excludes head and facial nodes and stores only coordinate data without preserving any pixel information that could reconstruct the human silhouette. Subsequently, the coordinate sequences of each node from consecutive frames are concatenated and input into a Transformer-based self-attention layer, which automatically focuses on the time segments with the most intense motion changes, generating spatio-temporal embeddings; then, through temporal convolution or an unfolding attention layer, it calculates limb coordination (symmetrical swing amplitude and phase difference between left and right), trunk stability (rate of change in horizontal inclination angle), and vertical sinking speed and acceleration characteristics, ultimately outputting a high signal-to-noise ratio time-series dynamic feature vector. The model, after parameter pruning and quantization optimization, can maintain a throughput of over 30 frames per second on low-power edge devices; simultaneously, retaining only essential skeleton node coordinates significantly reduces the risk of data leakage, complying with global privacy regulations such as GDPR.

In this embodiment, the artificial intelligence target-detection module 121 further includes a positioning module 1215. This positioning module 1215 calculates the relative coordinate position of target 3 corresponding to the water 2 from the images of the water 2. The processing and alert-issuance module 123 then transmits the relative coordinate position to the generative artificial intelligence module 122, which can generate a description of the position of the target. The positioning module 1215 is responsible for accurately mapping the image spatial coordinates output by the AI target-detection module 121 to the corresponding relative position on the water 2 plan, to facilitate subsequent alerts and on-site rescue guidance.

First, during the deployment phase, the system needs to perform internal and external parameter calibration of the image-capturing device 11 by using a plurality of pre-placed calibration markers in the water 2 or known dimensions at the poolside, establishing a homography transformation matrix between the image coordinate system and the actual planar coordinate system of the water 2. After the artificial intelligence target-detection module 121 identifies the pixel coordinates (u, v) of the target, the positioning module 1215 multiplies them by this homography matrix and combines depth estimation or triangulation from the image-capturing devices 11 to calculate the actual horizontal coordinates (X, Y) in three-dimensional space, retaining only the planar X-Y coordinates here to avoid storing any depth maps or personal silhouette information from the perspective of the image-capturing device 11, fully safeguarding privacy. Subsequently, the positioning module 1215 transmits the obtained relative coordinate position back to the processing and alert-issuance module 123 for generating specific alert messages and instructions; simultaneously, the relative coordinates are also sent to the generative artificial intelligence module 122, enabling it to produce natural language descriptions, such as “Target 3 is located in the third block of the main swimming lane, approximately 2.5 meters from the east poolside” or “An abnormal target 3 is detected, positioned slightly southwest of the center in the shallow water,” aiding lifeguards in quickly locating and assessing the on-site situation. The entire process is implemented on the edge-computing device 12 through lightweight matrix operations and lookup tables, ensuring low-latency and highly accurate positioning while completely avoiding the storage of any restorable image information, complying with GDPR and other privacy regulations.

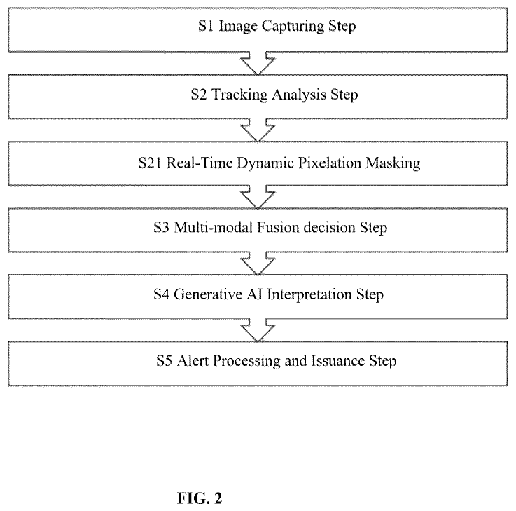

Next, please refer to FIG. 2, which discloses a water safety monitoring method based on artificial intelligence IoT according to the present disclosure, for monitoring a plurality of targets 3 in a water 2, including the following steps: Step 1, image capturing step S1: capturing continuous images of the water 2 in real time by an image-capturing device 11 and transmitting them to an edge-computing device 12; Step 2, tracking analysis step S2: using a visual attention heatmap tracking analysis submodule 1211 contained in an artificial intelligence target-detection module 121 in the edge-computing device 12, applying image saliency analysis techniques (e.g., Grad-CAM) to the captured images of the water 2 to generate a real-time dynamic attention heatmap 4, highlighting abnormal visual characteristics such as abnormal splashing and rapid sinking, and simultaneously using an AI multi-modal human skeleton dynamic sequence analysis submodule 1212 contained in the artificial intelligence target-detection module 121 to extract skeleton dynamic sequence characteristics 5 of limbs and trunk nodes of the plurality of targets 3 from the water 2 images in real time, and calculating dynamic metrics such as limb coordination, trunk motion stability, and vertical sinking speed and acceleration; Step 3, multi-modal fusion decision step S3: inputting the visual attention heatmap 4 and skeleton dynamic sequence characteristic map 5 from S2 into a multi-modal fusion decision neural network submodule 1213, using abnormal regions in the visual attention heatmap as trigger points for fusion decision, and when the skeleton dynamic metrics analysis results 51 and abnormal visual characteristics 41 simultaneously reach preset abnormal thresholds, generating a risk score 1214 for each target 3; Step 4, generative artificial intelligence interpretation step S4: in the edge-computing device 12, transmitting the outputs from S2 and S3—a real-time dynamic attention heatmap 4 and a skeleton dynamic sequence characteristic map 5—to a generative artificial intelligence module 122 to semantically interpret the behavior of target 3, and generating the target's drowning or falling risk score 1221 and/or text description 1222; Step 5, alert processing and issuance step S5: in the edge-computing device, weighting and combining the risk score generated in S4 and the risk score generated in S5, and when the combined score exceeds a preset threshold, triggering a processing and alert-issuance module to issue real-time alert notifications.

The method of the present disclosure first involves at least one image-capturing device 11 continuously capturing the surveillance area at 25-30 fps, and transmitting the footage to an edge-computing device 12 node; within the edge-computing device 12, a visual attention heatmap tracking analysis submodule 1211 uses image saliency techniques such as Grad-CAM to generate dynamic hotspot maps, highlighting abnormal visual characteristics such as unusual splashing, rapid sinking, or bubble clusters, while an AI multi-modal skeleton dynamic sequence analysis submodule 1212 employs HRNet or MobileNet combined with Transformer self-attention mechanisms, extracting only the 2D coordinates of key limb and trunk nodes, and calculating temporal indicators such as symmetrical swing coordination, trunk horizontal stability, and vertical sinking speed/acceleration; next, a multi-modal fusion decision neural network submodule uses the abnormal visual hotspot areas as triggers, jointly evaluating the abnormal visual characteristics 41 and skeleton dynamic metrics analysis results 51, generating a target risk score 1214 for each target when both exceed preset thresholds; subsequently, a generative AI module 122 receives the aforementioned hotspot map 4 and skeleton sequence features 5, performs semantic interpretation, and outputs a drowning or falling risk score 1221 and/or the target's textual description 1222; finally, a processing and alert-issuance module 123 weights and synthesizes the multi-source risk scores, triggering audio-visual or message alerts immediately when the comprehensive score of any target exceeds the set threshold, achieving real-time detection and reporting of underwater abnormal behavior. Additionally, this S2 further includes a real-time dynamic pixelation masking step, performing pixelation processing on an area within approximately 10 to 20 centimeters around the skeleton nodes of those targets 3, storing only the skeleton node and hotspot attention data.

The visual attention heatmap analysis is an interpretability technique based on deep convolutional neural networks (CNN), which dynamically highlights the most discriminative regions in an image by combining gradient backpropagation information. First, a pre-trained CNN architecture for object detection or classification (such as ResNet, VGG, or MobileNet) is selected, with the final convolutional layer designated as the feature map output layer. For each input image, the model performs forward propagation to obtain a classification score y^{c} (e.g., “abnormal” or “normal”), then backpropagates this score to compute the gradient ∂y^{c}/∂A_{i,j}^{k} for each channel at spatial coordinates (i, j) in the final convolutional layer. Next, these gradients are globally averaged across the spatial dimensions to generate channel weights aₖ^{c}, reflecting the relative importance of each channel to the classification result. Finally, each channel's feature map A^{K} is multiplied by its corresponding weight, summed, and passed through a ReLU function to remove negative contributions. The result is interpolated and upscaled to the original image size, yielding a color heatmap. This heatmap typically uses a red-yellow-green-blue gradient to indicate attention intensity, clearly highlighting abnormal visual characteristics such as unusual splashes, rapid sinking, or bubble clusters, without storing any facial or human silhouette information—relying solely on heat intensity for anomaly detection. In edge computing environments, to balance real-time performance and computational resources, lightweight variants of Grad-CAM like Grad-CAM++ or Score-CAM can be employed; faster implementations may retain only partial channels or use blind masking to quickly estimate channel contributions. To further enhance robustness, techniques such as Integrated Gradients or SmoothGrad can be integrated, averaging heatmaps from a plurality of noise-augmented images to reduce noise impact, and fine-tuning the ReLU threshold based on scene characteristics to avoid over-diffusion or suppression of weak signals. Overall, the visual attention heatmap analysis model not only precisely identifies the most judgmentally valuable dynamic regions in water scenes without exposing personal data but also seamlessly integrates with skeleton sequence analysis and multi-modal fusion decision networks, providing an efficient, interpretable, and privacy-compliant water safety monitoring solution.

### REFERENCE SIGNS

S1: Image Capturing Step
S2: Tracking Analysis Step
S2a: Real-Time Dynamic Pixelation Masking Step
S3: Multi-modal Fusion decision Step
S4: Generative AI Interpretation Step
S5: Alert Processing and Issuance Step
1: Artificial Intelligence IoT Water Safety Monitoring System
2: Water (Monitoring Area)
3: A plurality of Targets
4: Real-Time Dynamic Attention Heatmap
41: Abnormal Visual Characteristics
5: Skeleton Node Sequence Characteristics
51: Skeleton Dynamic Metrics
6: Simulated Visual Attention Heatmap
7: Simulated Skeleton Dynamic Sequence Characteristics
11: Image-capturing Device
12: Edge-computing Device
121: Artificial Intelligence Target-detection Module
1211: Visual Attention Heatmap Tracking Analysis Submodule
1212: AI Multi-modal Human Skeleton Dynamic Sequence Analysis Submodule
1213: Multi-modal Fusion Decision Neural Network Submodule
1214: Target Risk Score
1215: Positioning Module
122: Generative Artificial Intelligence Module
1221: Target's Drowning or Falling Risk Score
1222: Target's Textual Description
123: Processing and Alert-issuance Module
13: Audio Alarm Device
14: Visual Warning Device

What is claimed is:

1. An artificial intelligence IoT water safety monitoring system for monitoring a plurality of targets in a water, comprising:
an image-capturing device for capturing real-time images of the water and transmitting the images to an edge-computing device;
an artificial intelligence target-detection module disposed in the edge-computing device, wherein the artificial intelligence target-detection module comprises a visual attention heatmap tracking analysis submodule configured to use image saliency analysis technology to generate a real-time dynamic attention heatmap from the captured water images, an AI multi-modal human skeleton dynamic sequence analysis submodule configured to extract in real time trunk skeletal node sequence characteristics and limb skeletal node sequence characteristics of the plurality of targets from the captured water images, and a multi-modal fusion decision neural network submodule configured to receive the visual attention heatmap and the skeleton dynamic sequence characteristics, calculate dynamic metrics of limb coordination, trunk motion stability, and vertical sinking of the plurality of targets, highlight abnormal splashing, rapid sinking and other abnormal visual characteristics, use abnormal regions in the visual attention heatmap as trigger points for fusion decision, and when analysis results of the dynamic metrics and the abnormal visual characteristics simultaneously reach preset abnormal thresholds, generate a risk score of each target;
a generative artificial intelligence module disposed in the edge-computing device, wherein the edge-computing device transmits the visual attention heatmap and the skeleton dynamic sequence characteristics to the generative artificial intelligence module for interpretation of behaviors of the target, and the generative artificial intelligence module generates a target's drowning or falling risk scores and/or target's textual description based on the visual attention heatmap and the skeleton dynamic sequence characteristics; and
a processing and alert-issuance module disposed in the edge-computing device, wherein when a combined score of the target risk score and the target's drowning or falling risk score exceeds a preset threshold, the edge-computing device triggers the processing and alert-issuance module to issue an alert notification.

2. The artificial intelligence IoT water safety monitoring system according to claim 1, wherein the generative artificial intelligence module is further capable of scheduling generation of a simulated visual attention heatmap and a simulated skeleton dynamic sequence characteristic.

3. The artificial intelligence IoT water safety monitoring system according to claim 1, further comprising an audio alarm device and a visual warning device, wherein the audio alarm device and the visual warning device are connected to the edge-computing device.

4. The artificial intelligence IoT water safety monitoring system according to claim 1, wherein the processing and alert-issuance module sends notifications via a real-time communication tool, an SMS, an Email, and/or a Gateway.

5. The artificial intelligence IoT water safety monitoring system according to claim 1, wherein the generative artificial intelligence module uses generative adversarial networks or Vision Encoder and Language Model-based multi-modal technology for risk assessment and scenario description generation.

6. The artificial intelligence IoT water safety monitoring system according to claim 1, wherein the visual attention heatmap tracking analysis submodule inputs the real-time images of the water captured by the image-capturing device into a visual attention heatmap analysis model to generate a real-time visual attention heatmap, where dynamically salient regions are highlighted in an image area, optionally comprising abnormal visual characteristics selected from abnormal splashing, abnormal bubbles, rapid target sinking, or any combination thereof.

7. The artificial intelligence IoT water safety monitoring system according to claim 1, wherein the multi-modal human skeleton dynamic sequence analysis submodule employs a lightweight multi-modal skeleton recognition model, optionally HRNet or MobileNet combined with a Transformer neural network architecture, to identify skeleton nodes of individuals in a pool in real time and generate skeleton dynamic sequence characteristics.

8. The artificial intelligence IoT water safety monitoring system according to claim 1, wherein the target-detection module further comprises a positioning module configured to calculate relative coordinate positions of the targets in a planar graph of the water based on the images of the water from the artificial intelligence target-detection module, and the processing and alert-issuance module then transmits the relative coordinate positions to the generative artificial intelligence module to generate descriptions of the positions of the targets.

9. A water safety monitoring method based on artificial intelligence IoT for monitoring a plurality of targets in a water, comprising the following steps:
Step 1, image capturing step: capturing continuous real-time images of the water by an image-capturing device and transmitting the images to an edge-computing device;
Step 2, tracking analysis step: in the edge-computing device, applying image saliency analysis techniques (e.g., Grad-CAM) to the captured water images by a visual attention heatmap tracking analysis submodule to generate a real-time dynamic attention heatmap to highlight abnormal splashing, rapid sinking and other abnormal visual characteristics, and simultaneously, in the same edge-computing device, extracting in real time limb and trunk skeleton node sequence characteristics of the plurality of targets from the images of the water by a multi-modal human skeleton dynamic sequence analysis submodule, and calculating limb coordination, trunk motion stability, vertical sinking speed and acceleration and other dynamic metrics;
Step 3, multi-modal fusion decision step: inputting the visual attention heatmap characteristics from Step 2 and the skeleton dynamic sequence characteristics into a multi-modal fusion decision neural network submodule, using abnormal regions in the visual attention heatmap as trigger points for fusion decision, and when analysis results of the dynamic metrics and abnormal visual characteristics simultaneously reach preset anomaly thresholds, generating a risk score of each target;
Step 4, generative artificial intelligence interpretation step: in the edge-computing device, transmitting an attention heatmap and a skeleton characteristic output from Steps two and three to a generative artificial intelligence module, and the generative artificial intelligence module performing semantic interpretation for behaviors of the targets and generating drowning or falling risk scores and/or textual descriptions of the targets; and
Step 5, alert processing and issuance step: in the edge-computing device, weighting and combining the risk scores generated in Step 4 with the risk score generated in step 5, and when a combined score exceeds a preset threshold, triggering a processing and alert-issuance module to issue real-time alert notifications.

10. The water safety monitoring method based on artificial intelligence IoT for monitoring a plurality of targets in a water according to claim 9, wherein the Step 2 further comprises a real-time dynamic pixelation masking step, where pixelation processing is performed on areas approximately 10 to 20 centimeters around skeleton nodes of the targets, and only the skeleton nodes and heatmap attention data are stored.
